(19) United States
(12) Patent Application Publication
(10) Pub. No.: US 2003/0217687 A1
(43) Pub. Date: Nov. 27, 2003

(54) Re-stickable bookmark incorporating advertisements with place holders

(76) Inventor: Peter Lance Segall, New York, NY (US)

Correspondence Address: HANDAL & MOROFSKY, 80 WASHINGTON STREET, NORWALK, CT, 06854, US

(21) Appl. No.: 10/154,166

(22) Filed: May 22, 2002

(51) Int. Cl. B42D 9/00

(52) U.S. Cl. 116/234

(57) ABSTRACT

An object of the present invention is to provide a bookmark with a place holder(s) and tabs that also serves a dual purpose to provide a new channel of advertising. The inventive product allows readers to use the bookmark with place holder(s) to mark the place or places where the reader stopped reading the text or where the reader wishes to return to particular pages while also allowing advertisers to advertise products and services on the bookmark and place holder, said advertising being viewed by readers each time the reader opens a text. Furthermore, the present invention allows the reader to easily affix and remove the bookmark for repeated use.

### STATEMENT REGARDING FEDERALLY SPONSORED RESEARCH OR DEVELOPMENT

(Not applicable)

### TECHNICAL FIELD OF THE INVENTION

The present invention relates to a bookmark incorporating restickable adhesive with advertisements on the face(s) of the bookmark with place holder(s) which are affixed to a bound text and used to mark the places(s) where a reader stopped reading in a text. Incorporated within the invention are tabs also with restickable adhesive which tear-off and may be used to mark a page or a place within a page where a reader stopped reading in a text.

### BACKGROUND OF THE INVENTION

Despite the rapid expansion of the use of computers and media across the world, the need and desire to read printed text remains extant. Reading is still very much a part of everyday life around the world. Computers and modern technology have not been able to replace the act of reading printed text. Printed texts are read for both work and enjoyment.

In the modern world of globalized media, advertising plays a major role in the lives of the consuming public. Advertising can be seen on computers, on television, on the radio, on billboards, in magazines, on consumer products, on web sites, and in almost every imaginable way.

The use of bookmarks to mark a place in a printed text is not a new concept. Bookmarks have been around for years and come in various shapes and sizes. Bookmarks are generally cardboard, plastic or metal and often have a wide variety of designs or printed matter on them. Such printed matter may comprise a decorative design or a well known saying.

Bookmarks are typically used by placing the marking device between two pages of a bound text, near the spine of the text, in order to mark a particular page in the book where the reader left off and wants to return or which contains information to which the reader expects to refer back to.

Bookmarks come in many different forms. Bookmarks may take the form of a ribbon secured to the binding of a book to prevent the ribbon bookmark from falling out of the book or from being lost.

Bookmarks are made in plastic, cardboard, and metal. Some bookmarks have a tongue cut into them, allowing the tongue to be placed on one side of a page and the rest of the bookmark on the other side of the same page, like a paper clip, allowing the bookmark to remain secured to the page. Bookmarks may also be comprised of magnets wherein a page of a book rests in between two magnets which hold the page, allowing the bookmark to remain secured to the page.

Another form of a bookmark is an adhesive flag or tab which is affixed to a page and which sticks up out of the book to indicate the page marked by the reader. These adhesive flags and tabs allow the reader to easily affix and to remove the place holder.

### SUMMARY OF THE INVENTION

The inventive bookmark comprises a support member having a front surface and a back surface, printed indicia disposed on the front or back surface, an adhesive disposed on the back surface for affixing to and removing from a bound text, and an elongated flexible length of material secured to the support member for use as a place holder. Additionally, the bookmark may contain pull off tabs for use in marking a line or paragraph in a page of particular interest to the reader or for later referral or to mark the exact place left off by the reader complimenting the ribbon place holder which marks the page.

### BRIEF DESCRIPTION OF THE DRAWINGS

FIG. 1a is a plan view of the invention showing the bookmark affixed to a bound text with the front surface incorporating printed indicia facing toward the viewer and the place holder(s) looping over the bound text;

FIG. 1b is a cross-sectional view along lines 1b-1b of FIG. 1a;

FIG. 1c is a cross-sectional view along lines 1c-1c of FIG. 1a;

FIG. 2 is a frontal view of the front surface of the bookmark with place holder(s);

FIG. 3 is a rear view of the back surface of the bookmark showing the place holder adhered to the back surface;

FIG. 4 illustrates an open bound text with the place holder marking a page in the bound text; and

FIG. 5 illustrates a bound text in the closed position with the place holder looped over the top of the pages of the text, marking a page in the bound text.

### DETAILED DESCRIPTION OF THE PREFERRED EMBODIMENT

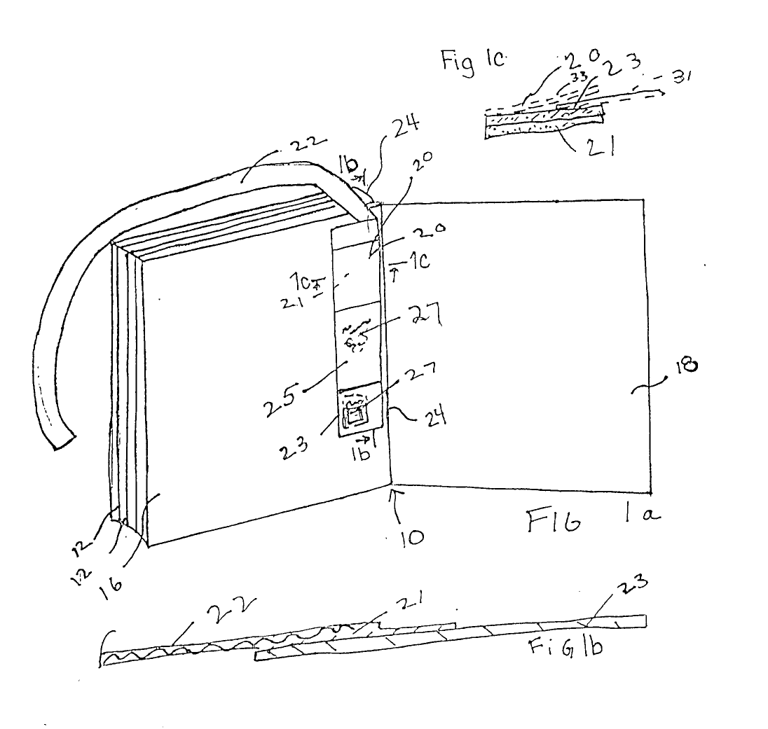

FIGS. 1a, 1b, and 1c illustrate the preferred embodiment of the present invention. A typical bound book 10, which may be a paperback or hardcover book, is shown comprising a number of pages 12 and a last page 16 of book 10 and a back cover 18. As illustrated in FIGS. 1a and 1b, book 10 is shown with the book open to the back cover so that all pages 12 lay flat against the front cover, which is not shown in the illustration.

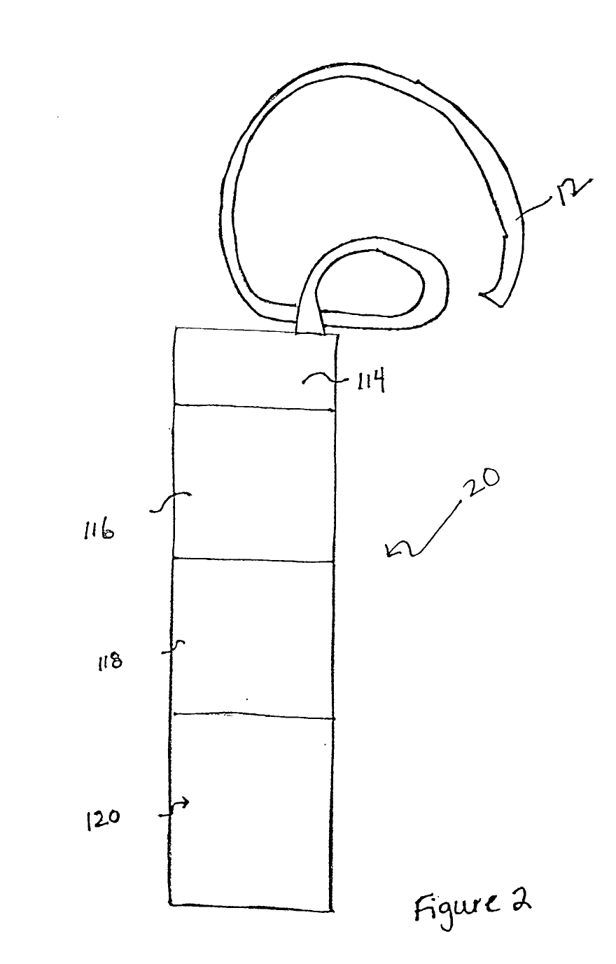

Bookmark assembly 20 is affixed to last page 16 by a layer of temporary adhesive 21, which covers all or part (as illustrated) of the underside of the bookmark assembly, such as that used in Post-it brand note pads made by 3M Corporation, which allows the bookmark assembly 20 to be removed from and replaced on page 16, or another page. Bookmark assembly 20 comprises a base member 23, which may be made of paper, covered with layers of temporary adhesive 21. It is the preferred embodiment of the invention that the bookmark assembly 20 be affixed near the binding 24. Alternatively, bookmark assembly 20 may be affixed anywhere on any page 16 or anywhere on the book. Bookmark assembly 20 may be made of paper, cardboard or other suitable material such as plastic, composite fiber, composite fiber plastic, or the like. Place holder 22 comprises a length of lightweight narrow ribbon of the type typically used to mark pages in a bible, as is more clearly illustrated in FIG. 2. Place holder 22 may be glued by any appropriate adhesive to the back or front surface of bookmark 20 and is shown looping over the top of the book 10. Other ways of securing place holder 22 to base member 23 may be employed, such as lamination between a plastic and a paper layer, or between two plastic layers.

Referring to FIG. 1, bookmark assembly 20 is shown with the front surface 25 of bookmark assembly 20 facing the reader. Front surface 25 may incorporate printed indicia 27, which may take the form of advertisements, a picture selected by a user or the like.

Referring to FIG. 1c, in accordance with one embodiment of the invention, a personal photograph 31 (illustrated in phantom lines) may be inserted into a pocket formed by a clear flexible plastic member 33 (illustrated in phantom lines) on bookmark assembly 20.

Bookmark assembly 20 may be removed from page 16 or any other location by lifting one or more corners of bookmark assembly 20 from a page 16 and peeling bookmark assembly 20 off page 16 until removed.

In FIGS. 1a, 1b, and 1c, the preferred embodiment of the place holder 22 is a paper or cloth ribbon. In the alternative, the place holder 22 may be made out of any cloth material or any flexible material such as plastic and may consist of one or more ribbons.

In accordance with the embodiment illustrated in FIGS. 1a, 1b, 1c and 2, it is contemplated that a temporary adhesive 21 will be used to allow the bookmark assembly 20 to be removed, put beside open book 10, which may be a catalog, for example, and referred to by the user as he is reading the catalog.

Referring to FIG. 2, this figure shows a frontal view of the front surface of bookmark assembly 10 with a place holder 12. As can be seen in FIG. 2, the front surface is sectioned into four different spaces 114, 116, 118, and 120 which may be used to carry printed indicia, such as advertisements. It is noted that the printed indicia spaces 114-120 may be configured in any size and may include more or fewer spaces.

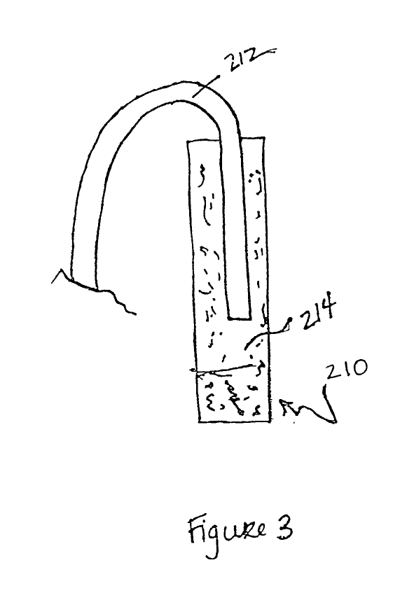

FIG. 3 shows a rear view of the back surface of an alternative embodiment of the inventive bookmark assembly 210 with a place holder 212. Place holder 212 is affixed to the back surface of bookmark assembly 210 using only a layer of temporary adhesive 214. Layer of temporary adhesive 214 also serves the purpose of securing bookmark assembly 210 in place in a book with much the same function as the function of temporary adhesive 21 in the FIGS. 1a, 1b, and 1c embodiment. The preferred embodiment shows the temporary adhesive 214 applied to the entire back surface of bookmark assembly 210. Alternatively, only a portion of the back surface of the bookmark assembly 210 may be covered with temporary adhesive 214. The portion not coated with adhesive may carry additional indicia of any kind. Place holder 212 may be affixed to any part of the back surface of bookmark assembly 210 or to the front surface. However, the preferred embodiment of the invention shows place holder 212 affixed to the middle of the back surface of bookmark assembly 210.

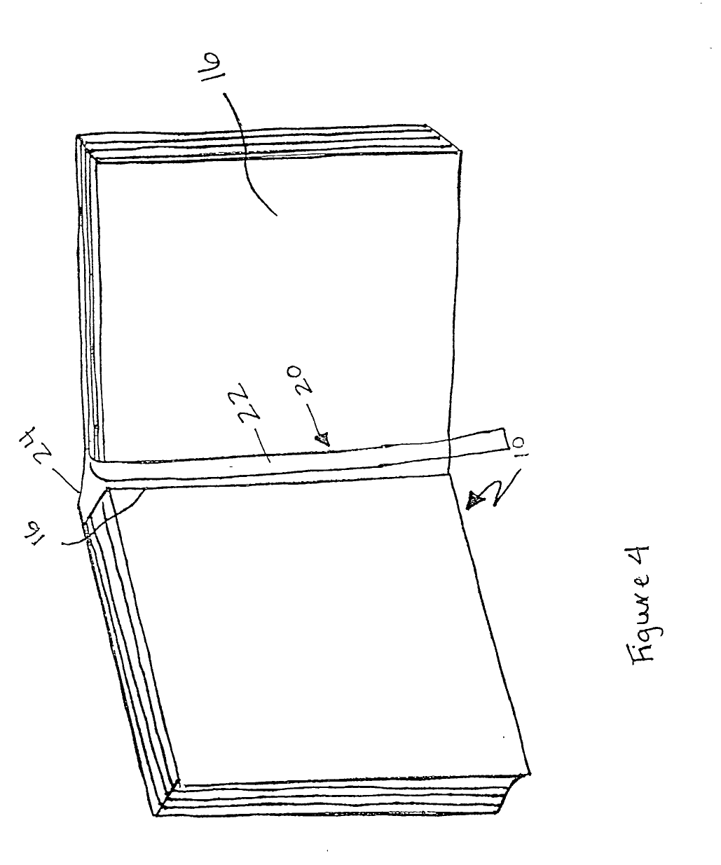

FIG. 4 illustrates an open book 10 with place holder 212 lying flat against a book page 16 near the book binding 24. In order to achieve this preferred embodiment, the bookmark assembly 20 as shown in FIGS. 1a, 1b, and 1c, must be affixed to a page 16 near the binding 24. The place holder 22 extends from the bottom of the book and immediately identifies the place to which the reader wants to return.

In accordance with the preferred embodiment of the invention, the printed indicia may be advertising for products and services. However, other printed indicia such as decorative designs, tables of weights and measures and the like, and/or references to particular favored pages in a text, such as a catalogue and well known sayings may be used.

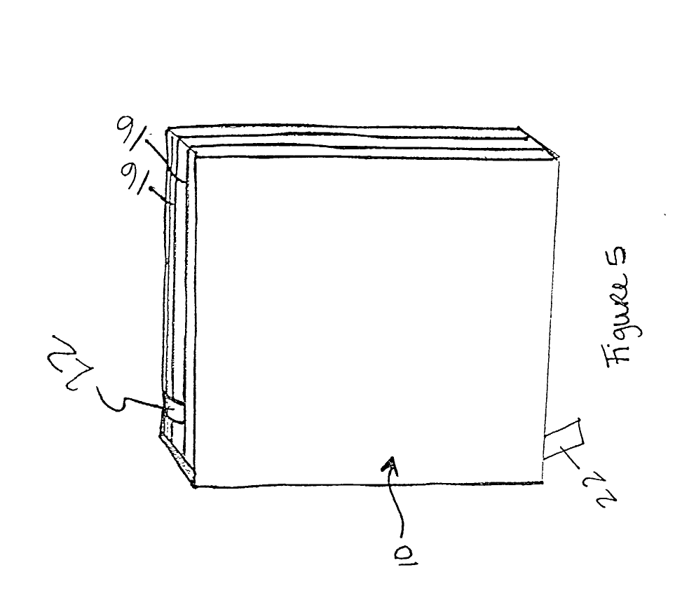

FIG. 5 illustrates bound book 10 in a closed position with place holder 22 looped over the top of pages 16 and which is visible when the book is closed.

While illustrative embodiments of the invention have been described, it is understood that various modifications may be obvious to those of ordinary skill in the art. Such modifications are within the spirit and scope of the invention, which is limited and defined only by the appended claims.

1. A bookmark, comprising a support member having a front surface and a back surface, printed indicia disposed on said front or back surface, an adhesive disposed on said back surface for affixing to and removing from a bound text, and an elongated flexible length of material secured to said support member for use as a place holder.

2. The bookmark according to claim 1 wherein the adhesive is temporary whereby said bookmark may be repeatedly affixed and removed from said bound text.

3. The bookmark of claim 1, in combination with a bound text, wherein the bookmark is affixed to said bound text and the length of material acting as a place holder is looped over the top of the pages and rests in between two pages for marking a page and protrudes from the bottom for easy identification of the last page or any page read.

4. The bookmark of claim 1 wherein the piece of material as a place holder comprises printed indicia, for example, advertisements.

5. The bookmark of claim 1 wherein the bookmark is affixed to the last page of a bound text.

6. The bookmark of claim 1 wherein the bookmark is affixed to any page of a bound text.

7. The bookmark of claim 1 wherein the support member comprises ribbon, cloth, or flexible plastic.

8. The bookmark of claim 1 wherein the piece of material as a place holder is adhered to the back surface of the bookmark.

9. The bookmark of claim 1 wherein the printed indicia on the front surface of the bookmark is advertising, engineering tables, references to particular pages in a book or indicia that may be handwritten and used by the reader as reminders as for example of some appointment.

10. A bookmark, comprising a support member having a front surface and a back surface, a temporary adhesive disposed on said back surface for affixing to and removing from a bound text, and an elongated flexible length of material secured to said support member for use as a place holder.

11. The bookmark of claim 10, further comprising printed indicia disposed on said front surface.

12. The bookmark of claim 10, wherein said elongated flexible length of material is a length of ribbon.

13. The bookmark of claim 10, further comprising a transparent planar plastic member disposed on said front surface to form a pocket for receiving a printed member such as a photograph.

14. The bookmark of claim 10, further comprising a transparent planar plastic member disposed on said front surface to form a pocket for receiving a printed member such as a photograph, and wherein said elongated flexible length of material is secured to said support member by being laminated to said transparent planar plastic member.

15. The bookmark of claim 10, wherein said elongated flexible length of material is secured to said support member by glue.

16. The bookmark of claim 10, wherein said elongated flexible length of material is secured to said support member by being laminated thereto.

17. The bookmark of claim 1, wherein said bookmark incorporates pull off tabs for use in marking a line or paragraph in a page of particular interest to the reader or for later referral or to mark the exact place left off by the reader complimenting the ribbon place holder which marks the page.
